(19) United States
(12) Patent Application Publication
(10) Pub. No.: US 2026/0078883 A1
(43) Pub. Date: Mar. 19, 2026

(54) LED FIRE SIMULATION SYSTEMS AND METHODS

(71) Applicant: HNI Technologies Inc., Muscatine, IA (US)

(72) Inventors: Tommie Kelley, Lakeville, MN (US); Moffat Omuya, Lakeville, MN (US); Destin Peters, Lakeville, MN (US); Hunter Miller, Lakeville, MN (US); Jacob Clifton, Lakeville, MN (US); Timothy Johnson, Lakeville, MN (US); Douglas Deipenbock, Lakeville, MN (US); Corey Radloff, Lakeville, MN (US); Julie Milum, Lakeville, MN (US); Erika Saffer, Lakeville, MN (US); Joseph Kueffler, Lakeville, MN (US)

(21) Appl. No.: 19/329,029

(22) Filed: Sep. 15, 2025

Related U.S. Application Data
(60) Provisional application No. 63/694,635, filed on Sep. 13, 2024.

(51) Int. Cl. F21S 10/04; F21Y 115/10

(52) U.S. Cl. CPC F21S 10/04; F21Y 2115/10

(57) ABSTRACT

Various electric light and electric fireplace systems are disclosed herein. An electric light or electric fireplace system includes a housing, an array of light elements arranged in a planar display coupled to the housing, the array of light elements configured to display dynamic lighting, a cover extending over at least a portion of the array of light elements, a controller operatively coupled to the array of light elements, and optionally, a heating system including at least one heater associated with the housing.

### CROSS-REFERENCE TO RELATED APPLICATION

This application claims the benefit of Provisional Application No. 63/694,635, filed Sep. 13, 2024, which is incorporated herein by reference in its entirety for all purposes.

### BACKGROUND

Rotisserie fireplaces include a rotisserie system having a rotating rod driven by an electric motor. Inclusion of the rotisserie system can increase the depth and complexity of the fireplace, in some examples adding at least 6 inches of depth, which may require an in-wall installation within a wall cavity carved into the wall. Creation of the wall cavity can be messy, expensive, and impractical for consumers with limited wall space, such as in an apartment or a mobile home. Additionally, inclusion of mechanical rotisserie components can create unwanted noise during operation of the fireplace leading to service calls and warranty repairs.

New electric fireplaces with digital displays have aimed to overcome these challenges, but can still be difficult for consumers to install or mount to a wall in the orientation they prefer.

### SUMMARY

Some of the inventive concepts shown here improve the manner by which an electric light and/or a fire display system may be installed or mounted to a wall by allowing a user to mount the display a variety of orientations. Other concepts show a product which may be positioned on a horizontal surface, such as the floor or table. Others show improvements to the visual features of a fire display system. The electric light and electric fireplaces may mimic features of a burning fire without the need to install a gas line or other fuel sources. In some embodiments, the electric lights and electric fireplaces include one or more accessories, such as at least one of a heating system, a speaker system, and a scent diffuser to mimic features of a burning fire. The lights (e.g., LEDs) of the electric lights and electric fireplaces may be operatively coupled to a chaos circuit to mimic movement of real flames. The following summary is not meant to be an exclusive list of the inventive concepts addressed by this patent specification.

In one embodiment (Embodiment 1), an electric light system comprises a housing, an array of light elements arranged in a planar display coupled to the housing configured to display dynamic lighting, a cover extending over at least a portion of the array of light elements, a controller operatively coupled to the array of light elements, and a heating system including at least one heater associated with the housing.

In another embodiment (Embodiment 2), further to Embodiment 1, the controller is configured to be operatively coupled to a smart home system.

In another embodiment (Embodiment 3), further to Embodiment 1 or 2, the heating system is configured to be operatively coupled to the smart home system, and optionally, the heating system is configurated to be operatively coupled to the smart home system via the controller.

In another embodiment (Embodiment 4), further to any one of Embodiments 1-3, the electric light system includes a speaker system including at least one speaker associated with the housing.

In another embodiment (Embodiment 5), further to Embodiment 4, the speaker system is configured to be operatively coupled to a smart home system, and optionally wherein the speaker system is configured to be operatively coupled to the smart home system via the controller.

In another embodiment (Embodiment 6), further to any one of Embodiments 1-5, the electric light system includes a scent diffusion system including at least one scent diffuser coupled to the housing.

In another embodiment (Embodiment 7), further to Embodiment 6, the scent diffusion system is configured to be operatively coupled to a smart home system, and optionally the scent diffusion system is configured to be operatively coupled to the smart home system via the controller.

In another embodiment (Embodiment 8), further to any one of Embodiments 1-7, the array of light elements includes a plurality of LEDs.

In another embodiment (Embodiment 9), further to Embodiment 8, the plurality of LEDs are arranged in a matrix, and optionally wherein the matrix is one of a transparent, semi-transparent, translucent, or semi-translucent material.

In another embodiment (Embodiment 10), further to any one of Embodiments 1-9, the cover includes at least one of a transparent, semi-transparent, opaque, or semi-opaque material.

In another embodiment (Embodiment 11), further to any one of Embodiments 1-10, the electric light system includes a light extender configured to extend the lighting outwardly from the housing, the light extender including at least one of goboes, LEDs, and a projector.

In another embodiment (Embodiment 12), further to any one of Embodiments 1-11, the housing includes one or more embedded lights configured to display a word.

In another embodiment (Embodiment 13), further to any one of Embodiments 1-12, the housing includes one or more through-holes defining a shape.

In another embodiment (Embodiment 14), further to Embodiment 11, the shape is a flame.

In another embodiment (Embodiment 15), further to any one of Embodiments 1-14, the housing is a table.

In another embodiment (Embodiment 16), further to any one of Embodiments 1-15, the dynamic lighting simulates one of a flame, a shape, or abstract lighting.

In an embodiment (Embodiment 17), an electric light system is used with a smart home system. The electric light system comprises a housing having a front facing side and a rear facing side opposite the front-facing side, the front facing side including a translucent screen, an array of one or more light elements supported by the housing, the array of one or more light elements configured to display dynamic lighting, including one of flickering, pulsing, or changing colors, a speaker assembly coupled to the housing, a heating assembly coupled to the housing, a controller operatively coupled to the array of one or more light elements, the speaker assembly, and the heating assembly. The controller is configured to form part of a smart home system. The electric light system is configured to change a feature of the array of the one or more light elements according to at least one of an input signal to and an output signal from at least one of the speaker assembly and the heating assembly.

In another embodiment (Embodiment 18), further to Embodiment 17, when the electric light system is configured to operate such that an increase in heat production of the heat assembly is coordinated to an increase in a frequency of one of the flickering, pulsing, and changing color of the one or more light elements.

In another embodiment (Embodiment 19), further to Embodiment 17, the electric light system is configured to operate such that a decrease in heat production of the heat assembly is coordinated to a decrease in a frequency of one of the flickering, pulsing, and changing color of the one or more light elements.

In another embodiment (Embodiment 20), further to Embodiment 17, the electric light system is configured to operate such that an increase in volume of the speaker assembly is coordinated to an increase in a frequency of one of the flickering, pulsing, and changing color of the one or more light elements.

In another embodiment (Embodiment 21), further to Embodiment 17, the electric light system is configured to operate such that a decrease in volume of the speaker assembly is coordinated to a decrease in a frequency of one of the flickering, pulsing, and changing color of the one or more light elements.

In another embodiment (Embodiment 22), further to any of the Embodiments 17-21, the electric light system is configured to operate such that an increase in brightness of the array of light elements is coordinated to an increase in a frequency of one of the flickering, pulsing, and changing color of the one or more light elements.

In another embodiment (Embodiment 23), further to any of the Embodiments 17-22, the electric light system is configured to operate such that a decrease in brightness of the array of light elements is coordinated to a decrease in a frequency of one of the flickering, pulsing, and changing color of the one or more light elements.

In an embodiment (Embodiment 24), an electric fireplace includes a housing, a first display positioned at a front of the housing, the first display producing a first visual representation of a fire, a second display positioned at a rear of the housing opposite to the front of the housing, the second display producing a second visual representation of a fireplace, wherein the first and second display together provide a perceived depth to the electric fireplace, and a controller operatively coupled to the first and second displays, the controller operable to change one or more properties of the first and second displays in response to a user-input.

In another embodiment (Embodiment 25), further to Embodiment 24, the electric fireplace further includes a third display positioned along a side of the housing and extending between the first and second displays, the third display producing a third visual representation of a fireplace.

In another embodiment (Embodiment 26), further to any of the Embodiments 24-25, the first, second, and third display include LED panels, wherein at least one of the LED panels includes a transparent, semi-transparent, translucent, or semi-translucent material.

In another embodiment (Embodiment 27), further to any of the Embodiments 24-26, the first, second, and third displays define an outer perimeter of the housing, wherein the first and third visual representations of the fireplace are substantially continuous.

In another embodiment (Embodiment 28), further to any of the Embodiments 24-27, the electric fireplace further includes a simulated ember bed at a bottom of the housing, the simulated ember bed including a plurality LED lights configured to blink on and off.

In another embodiment (Embodiment 29), further to Embodiment 28, the simulated ember bed is operably coupled to a chaos circuit.

In another embodiment (Embodiment 30), further to any of the Embodiments 24-27, the electric fireplace further includes a simulated ember bed at a bottom of the housing, the simulated ember bed including an LED panel configured to display at least one of an image or a video of an ember bed.

In another embodiment (Embodiment 31), further to Embodiment 30, the first display is at least partially transparent and optionally wherein the second display is at least partially transparent.

In an embodiment (Embodiment 32), an electric fireplace includes a housing, an LED panel coupled to a top portion of the housing, the LED panel displaying a visual representation of a fire a cover material coupled to a bottom of the housing and positioned at an angle relative to the bottom of the housing, the cover material having one of a reflective or semi-reflective property, the cover material positioned such that the visual representation of the fire from the LED panel is reflected onto the cover material to produce a reflected visual representation of a fire, and wherein the reflected visual representation of the fire is directed outwardly toward a user.

In another embodiment (Embodiment 33), further to Embodiment 32, the electric fireplace further includes a simulated ember bed positioned at the bottom portion of the housing.

In another embodiment (Embodiment 34), further to any one of Embodiments 32-33, the cover material obscures features of the LED panel such that the reflected visual representation of a fire simulates a real fire.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure. For reference, the terms “top” or “upper”, “bottom” or “lower”, and “side” as used with regard to the orientation of the views are meant to denote orientations of the device at different rotational angles around the central longitudinal axis of the device. For example, where the “top” view corresponds to an angular rotation of 0 degrees, the “bottom” view would be offset from the “top” view at a rotational angle of 180 degrees, and the “side” view by a rotational angle of 90 degrees.

FIG. 1 illustrates an electric light, in accordance with an embodiment;

FIG. 2 illustrates an electric light including an opaque cover, in accordance with an embodiment;

FIG. 3 illustrates an electric light including a cover with a cutout, in accordance with an embodiment;

FIG. 4 illustrates an electric light in a stacked arrangement, in accordance with an embodiment;

FIG. 5 illustrates an electric light shaped as a radiator, in accordance with an embodiment;

FIG. 6 illustrates a table with an electric light, in accordance with an embodiment;

FIG. 7 illustrates an electric fireplace, in accordance with an embodiment;

FIG. 8 illustrates an electric light with a cover defining a word, in accordance with an embodiment;

FIG. 9A illustrates an electric light configured to display a flame, in accordance with an embodiment;

FIG. 9B illustrates an electric light configured to display one or more shapes, in accordance with an embodiment;

FIG. 9C illustrates an electric light configured to display abstract lighting, in accordance with an embodiment;

FIG. 10 illustrates an electric light system with one or more rear-facing light elements, in accordance with an embodiment;

FIG. 11 illustrates an electric light with one or more accessories operably coupled to the electric light, in accordance with an embodiment;

FIG. 12 illustrates a controller operatively coupled to the one or more accessories, in accordance with an embodiment;

FIG. 13 illustrates an electric fireplace, in accordance with an embodiment.

FIG. 14 illustrates an electric fireplace including an LED panel, in accordance with an embodiment;

FIG. 15 illustrates the LED panel of the electric fireplace of FIG. 14, in accordance with an embodiment;

FIG. 16 illustrates an electric fireplace configured to mount onto a wall, in accordance with an embodiment;

FIG. 17 illustrates a layered electric fireplace, in accordance with an embodiment;

FIG. 18 illustrates a layered electric fireplace including one or more side panels, in accordance with an embodiment;

FIG. 19 illustrates an electric fireplace with a cover material displaying a reflected representation of a fire, in accordance with an embodiment; and

FIG. 20 shows an example of a panel of an electric fireplace, in accordance with an embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### Description of Various Inventive Embodiments with Reference to the Figures

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting. The inventions described herein include, but are not limited, to the following description.

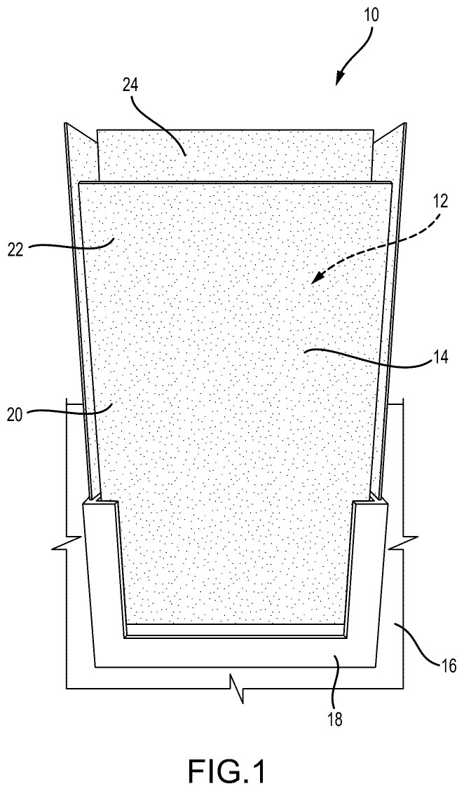

FIG. 1 shows an electric light 10 in accordance with an embodiment. The electric light 10 is configured to evoke the experience of a burning fire, without including a direct visual representation of the fire (e.g., without a video of a flame, flame-shaped lights, or other projections of a flame). Instead, the electric light 10 may be configured to create an illusion of a fire behind a screen, which leaves more to the imagination of a user and may simulate a realistic fire effect.

In some examples, the electric light 10 may include an array of light elements including an array of light emitting diodes (LEDs) 12 configured to cast light and/or shadows about an environment (e.g., a room) to simulate a burning flame. In some examples, and as further discussed below, the array of LEDs 12 are configured to be animated to mimic the flickering and bouncing nature of firelight.

LEDs of the array of LEDs 12 are extra low voltage (ELV), produce less heat, and use less energy compared to other lighting systems. By using less energy, the circuitry of the electric light 10 may be simplified and additional components such as heaters, speakers, and diffusers may be integrated with the electric light 10. LEDs may also be compatible with off-grid electric systems and may be alternatively configured to operate on other energy sources such as battery power or solar power, which offers alternative power options in the event of an electric outage.

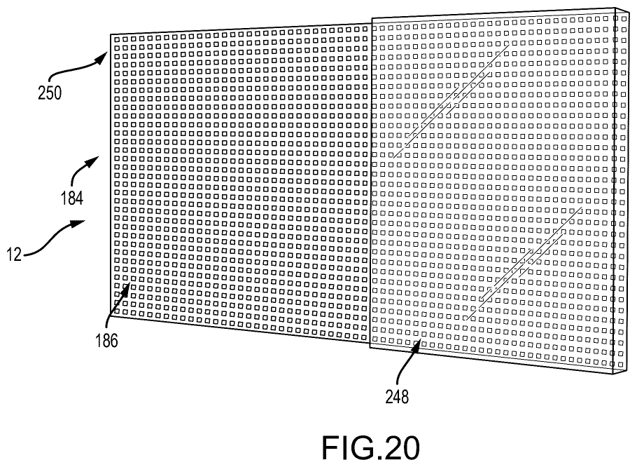

The array of LEDs 12 may be arranged in a matrix 250, as shown in FIG. 20. The matrix 250 may be a regular grid of LEDs 12, though any shape and configuration of the matrix 250 is contemplated. The array of LEDs 12 may include a material that is one of transparent, semi-transparent, translucent, or semi-translucent such that emitted light. In some embodiments, emitted light from the array of LEDs 12 is at least partially obstructed by the material to hide or obscure features such as the individual LEDs of the array of LEDs 12.

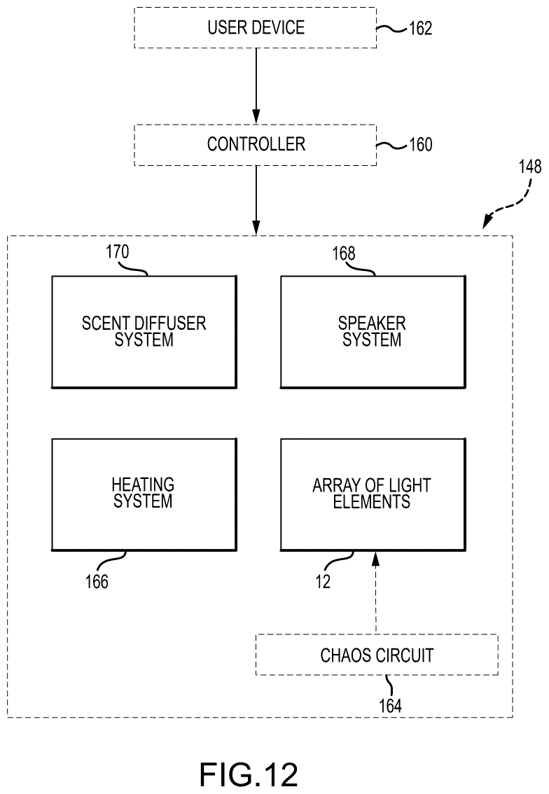

The electric light 10 may be operatively coupled to a controller 160 (FIG. 12) configured to turn the electric light 10 on and off, or change a brightness of the array of LEDs 12. The controller 160 may include, but is not limited to a remote, a smart home system, and/or a mobile app assessable from a user device 162 (FIG. 12) such as a cell phone or laptop. Further discussion of the controller 160 is included with respect to FIG. 12.

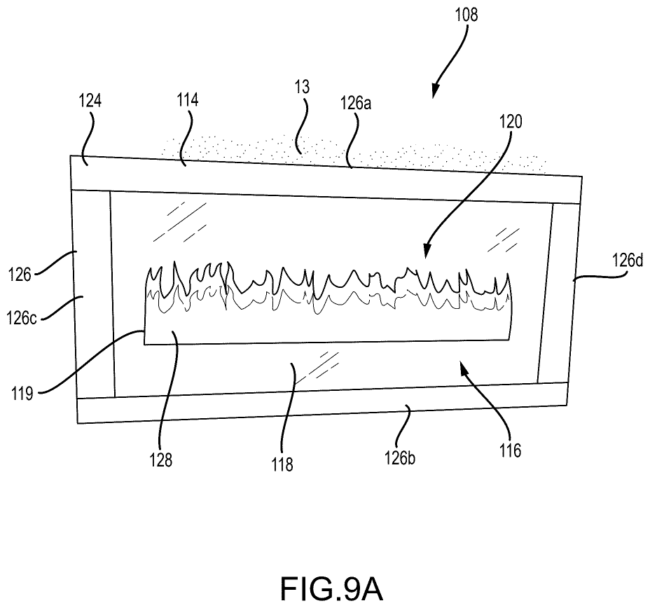

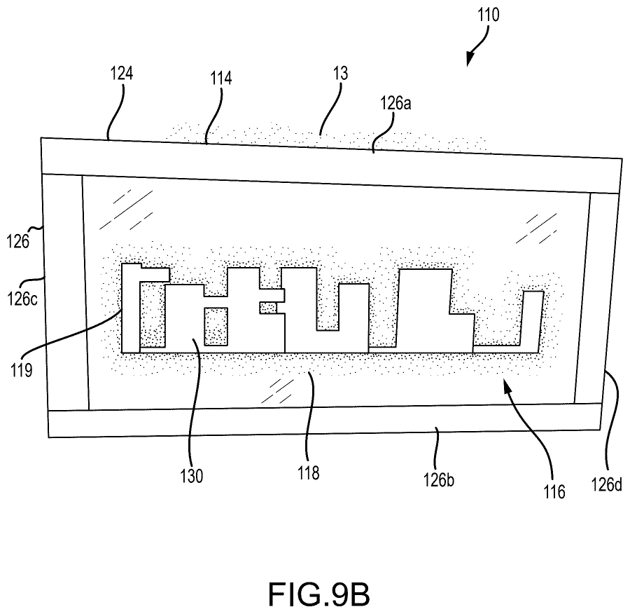

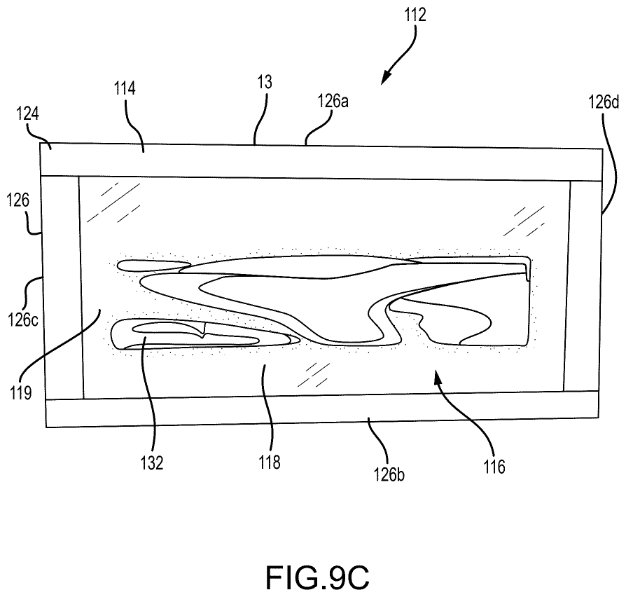

As shown in FIG. 1, the electric light 10 includes housing 14 to support the array of LEDs 12, where the array of LEDs 12 are configured to mimic burning flames. In some embodiments, the array of LEDs 12 is configured to display dynamic lighting to simulate a flame effect. In some examples, the flame effect is created by each LED of the array of LEDs 12 randomly turning on and off to simulate flickering, pulsing or scattering of light. In some embodiments, the array of LEDs 12 may also change colors. The array of LEDs 12 may be operated by a chaos circuit 164 (FIG. 12), such as the chaos circuit disclosed in U.S. patent application Ser. No.: 16/021,631 granted as U.S. Pat. No. 10,508,785, the entire disclosure of which is incorporated by reference. The array of LEDs 12 may be positioned in any shape, including but not limited to, a planar display 120 such as shown in FIG. 9A.

The dynamic lighting may be displayed about an environment of the electric light 10, such as along a wall, a table 16 and/or a floor about the electric light 10. The dynamic lighting increases realism of the electric light 10, such that the electric light 10 creates a cozy or warming environment without inclusion of burning flames.

The electric light 10 optionally includes a support 18 positioned at a bottom portion of the housing 14. As shown, the support 18 may include a stand configured to rest on a surface, such as the table 16. The housing 14 may further include a cover 20 surrounding at least a portion of the array of LEDs 12. The cover 20 may comprise materials that are translucent, semi-transparent, or semi-opaque, such that light can shine through at least a portion of the cover 20. The cover 20 may also be surface treated including, but not limited to, a frosted or sanded treatment. The cover 20 may include, but is not limited to, smoke treatment, film treatment, glass, granite, alabaster, or polycarbonate. The cover 20 may be reflective or semi-reflective and, optionally, can include a polarizing coating to reduce or prevent glare from other light sources in the environment. The cover 20 may blur or semi-obstruct the individual lights of the array of LEDs 12 to further simulate a flame appearance. The cover 20 may be separate from or integrated with the housing 14.

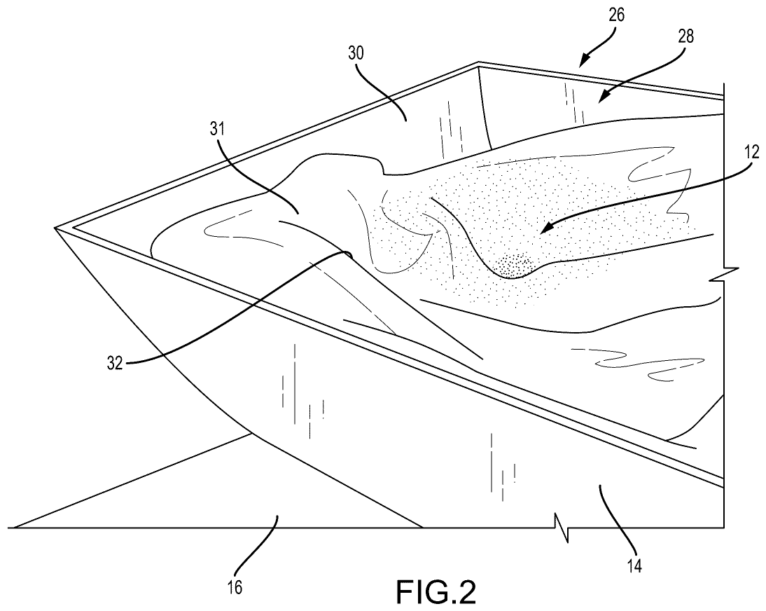

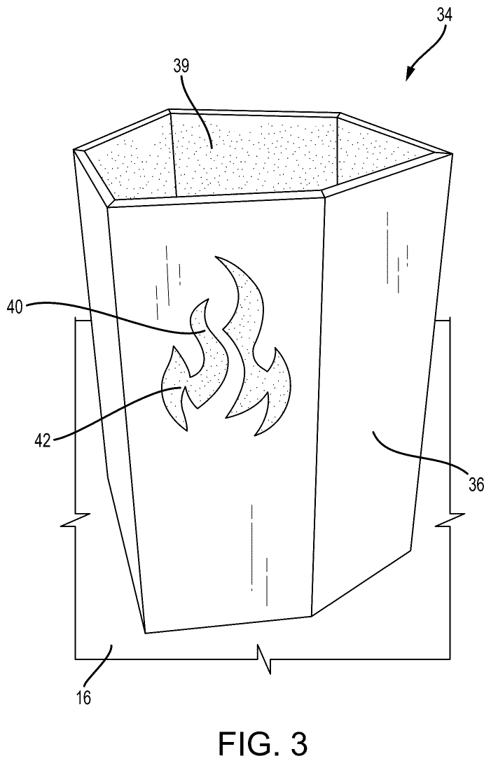

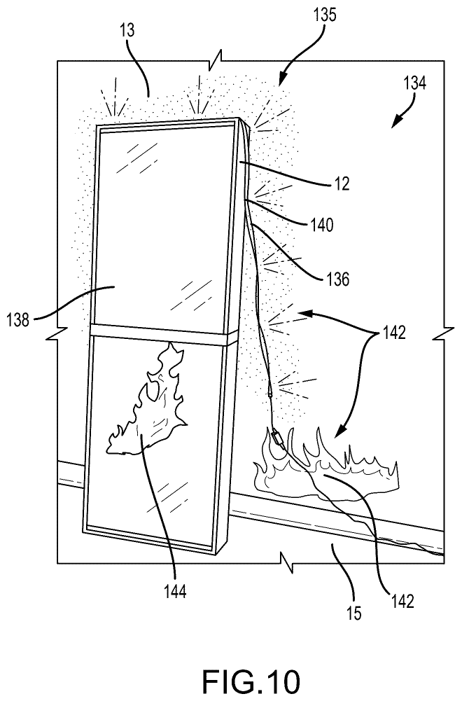

In some embodiments, the cover 20 is positioned about at least one face 22 of the electric light 10 (e.g., on a front-facing side) to produce a 2D flame effect (e.g., FIGS. 2-3). The other faces or sides not including the cover 20 may blocked with an opaque material such that no or minimal light is emitted and the emitted light is concentrated in one location at the cover 20. In other embodiments, and as shown in FIG. 1, more than one face 22 of the electric light 10 may be covered with a translucent material (e.g., covered on two or more faces of a generally rectangular light) to emulate a surrounding 360° or 3D fire effect. This can improve or increase a viewing angle for a user, as the light can be seen from multiple points of view. In some embodiments, a top face 24 of the electric light 10 is uncovered by the cover 20. The electric light 10 may include at least one of a projector, LEDs light, and/or go between optics (goboes) positioned within the housing 14 configured to act as a light extender 135 (FIG. 10) to shape the light emitted and extend the light beyond the internal surface of the housing 14 and onto other surfaces of the room such as a wall, the table 16, a ceiling, and/or a floor. This may enhance the lighting experience and expand the reach of the light beyond the housing 14. As shown in FIG. 10, the light extender 135 includes one or more rear-facing lighting elements 136.

FIG. 2 shows an electric light 26 in accordance with an embodiment. The electric light 26 includes substantially similar elements as the electric light 10 of FIG. 1.

As shown in FIG. 2, the array of LEDs 12 may be positioned within a housing 28. The housing 28 may be configured to rest on a table 16, and for example, can be used as a centerpiece light. As shown, one or more walls 30 of the housing 28 may comprise an opaque material that substantially blocks light emission. A top portion 32 of the housing 28 may be substantially open, allowing light from the array of LEDs 12 to be emitted from the top portion 32 to the room. The array of LEDs 12 may be covered by a translucent or semi-opaque material, which optionally includes fabric. Light from the array of LEDs 12 may be emitted through a cover 31 and out to the room. The light may be projected onto other surfaces of the environment such as a wall, the table 16, a ceiling, and/or a floor. As discussed with respect to FIG. 1, the array of LEDs 12 may be configured to display dynamic lighting to simulate a flame.

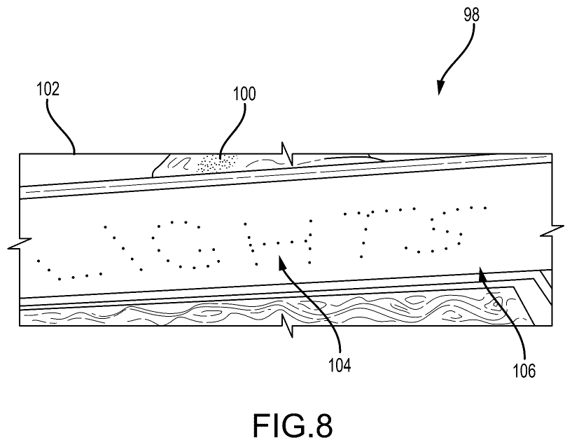

FIG. 3 shows an electric light 34 in accordance with an embodiment. The electric light 34 includes substantially similar elements as the electric lights 10, 26 of FIGS. 1-2. As shown in FIG. 3, the array of LEDs 12 may be positioned within a housing 36. As shown, the housing 36 may comprise an opaque material that substantially blocks light. The housing 36 may include a cutout 40 through a thickness of the housing 36 that allows light from the array of LEDs 12 to shine through. The cutout 40 may optionally include an image (e.g., a flame), or may display words (see, e.g., FIG. 8). The cutout 40 may concentrate the light emitted from the housing 36 such that the light illuminates the cutout 40. A translucent cover material 42 may be positioned over portions of the cutout 40 to blur the emitted light behind the cutout 40. The translucent material optionally includes parchment paper.

In some embodiments, a top portion 39 of the electric light 34 is uncovered, effectively extending the light beyond the housing 36 and onto other surfaces of the room such as a wall, a ceiling, the table 16, and/or a floor, similar to the features as discussed with respect to FIGS. 1-2.

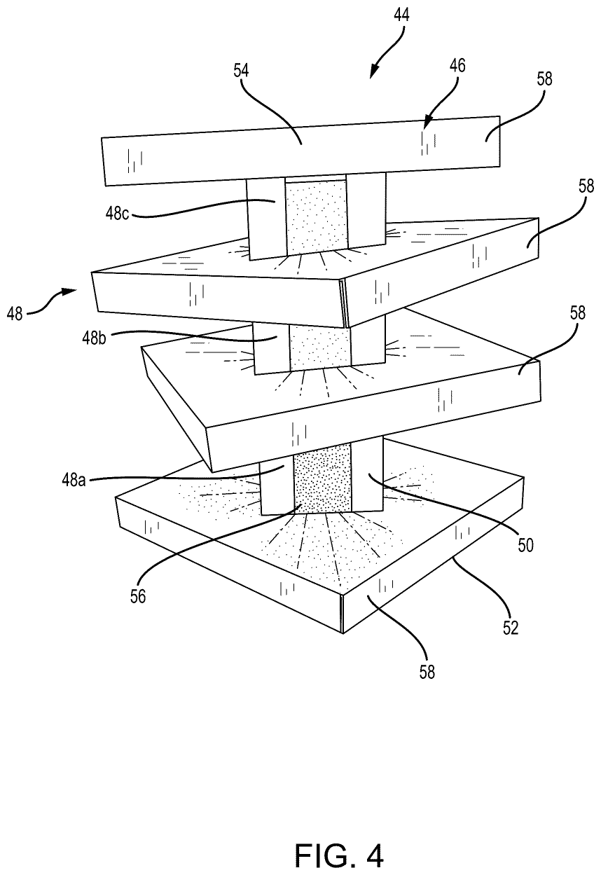

FIG. 4 shows an electric light 44 in accordance with an embodiment. The electric light 44 includes substantially similar elements as the electric lights 10, 26, 34 of FIGS. 1-3. As shown in FIG. 4, the electric light 44 may have a generally vertical stacked arrangement, or a tower array 46. The tower array 46 may include more than one light portion 48, optionally including three light portions 48 as shown. The more than one light portion 48 may be supported by a single array of LEDs 12, such as a vertical column extending from a bottom portion 52 of a housing 50 and toward a top portion 54 of the housing 50, such that the three portions of the light 48 effectively define one light. Alternatively, three separate arrays of the LEDs 12 may be used to create three separate lights positioned at the three light portions 48. The array(s) of LEDs 12 may all be configured to pulse, flicker, or change color to simulate a burning flame, and may be operatively coupled to a chaos circuit. In some examples, the plurality of light portions 48 may display a gradient of light from the bottom portion 52 to the top portion 54 of the housing 50, which in some examples, may simulate different lighting portions of burning flame. For example, a first light portion 48a closest to the bottom portion 52 of the housing 50 may be brighter than both a second light portion 48b and a third light portion 48c, where the bottom portion 52 of the housing 50 simulates a position of a fuel source of a burning fire. Similarly, the third light portion 48c positioned closest to the top portion 54 of the housing 50 is the least bright light portion, which simulates a top portion of a burning flame, or in other words, a point furthest from the fuel source.

A cover 56 may be positioned on at least a portion of each of the light portions 48 to blur the emitted light. The cover 56 may include a transparent material, optionally parchment paper. In other embodiments, the cover 56 is semi-transparent, semi-translucent, reflective, or semi-reflective.

The tower array 46 optionally includes a plurality of supports 58 positioned on the bottom portion 52 of the housing 50, between each of the light portions 48, and on the top portion 54 of the housing 50. The plurality of supports 58 may support a weight of the light portions 48.

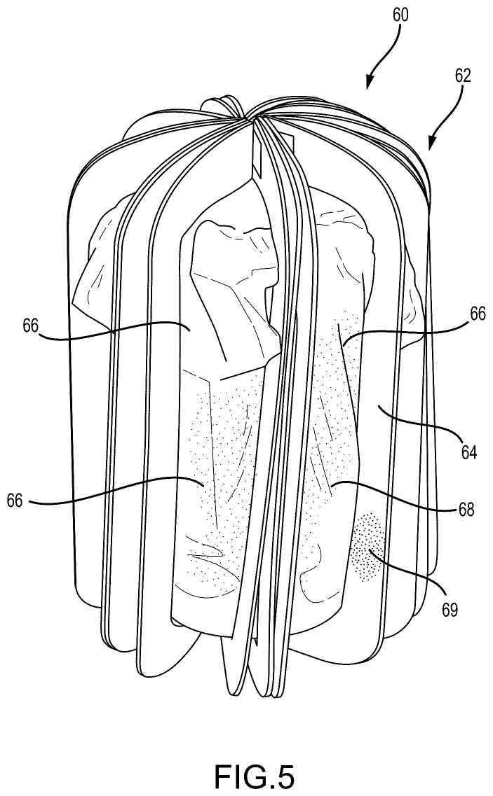

FIG. 5 shows an electric light 60 in accordance with an embodiment. The electric light 60 includes substantially similar elements as the electric lights 10, 26, 34, 44 of FIGS. 1-4. As shown in FIG. 5, the electric light 60 may be shaped similarly to a radiator 62. The radiator shape 62 is a familiar shape may appear warm to a user even in the absence of heaters or a burning flame. In some embodiments, the electric light 60 includes one or more heaters. As shown, the array of LEDs 12 are positioned within a housing 64, where a portion of the housing 64 may comprise an opaque material that substantially blocks light. As shown, the housing 64 may define one or more cutout areas 66 that allow light 69 from the array of LEDs 12 to shine through the housing 64. A translucent cover 68 may be positioned to blur the emitted light at each cutout area. The translucent cover 68 optionally includes fabric, including synthetic silk fabric.

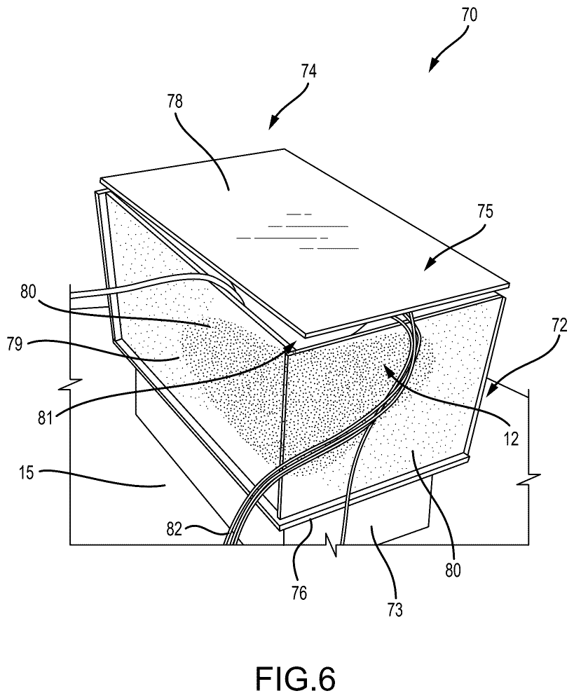

FIG. 6 shows an electric light 70 in accordance with an embodiment. The electric light 70 includes substantially similar elements as the electric light 10, 26, 34, 44, and 60 of FIGS. 1-5. As shown in FIG. 6, the electric light 70 may include a housing 72, which may be configured as a table 74 including but not limited to a coffee table. In other words, the electric light 70 is housed within the table 74. The housing 72 may include a support 76 on a bottom portion 73 of the housing 72 configured to rest on a floor 15 or the table 16. The support 76 may be generally opaque. The housing 72 may include a table top 78 on a top portion 75 of the housing 72, where the table top 78 is generally opaque. The housing 72 is generally rectangular in shape and includes four sides 79, though other shapes are contemplated. At least one of the four sides 79 may include translucent cover portions 80. The translucent cover portions 80 may optionally include hazy films laminated to acrylic. The housing 72 may define an interior portion 81 configured to house an array of LEDs 12 and associated electronic components 82. When turned on, light emitted from the array of LEDs 12 may be emitted through the translucent cover portions 80 of the housing 72 to provide light to the environment, where the translucent cover portions 80 of the housing 72 act as diffusers. Similar to other embodiments, the array of LEDs 12 may be configured to flicker, pulse, change color, or otherwise mimic a burning flame. The array of LEDs may be operatively coupled to a chaos circuit. Portions housing 72 may hide the internal electric components 82 from view to improve the aesthetic of the table 74.

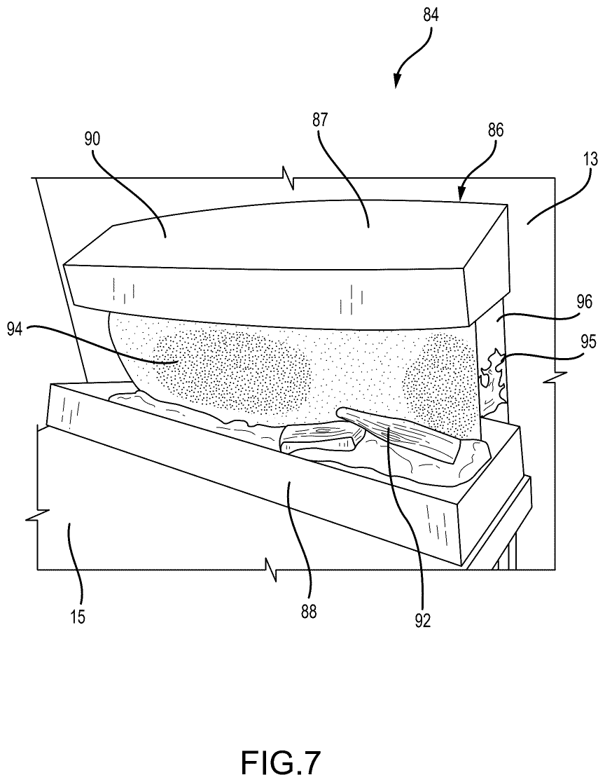

FIG. 7 shows an electric light 84 in accordance with an embodiment. The electric light 84 includes substantially similar elements as the electric lights 10, 26, 34, 44, 60, and 70 of FIGS. 1-6. As shown in FIG. 7, the electric light 84 includes a housing 86. The housing 86 includes a top portion 87 and a bottom portion 88, both of which may include substantially opaque materials that block light. The bottom portion 88 may be configured to rest on a table 16. In other embodiments, the housing 86 is configured to be mounted on a wall. The bottom portion 88 includes an upper surface 90 that may support portions of a simulated ember bed 92, including but not limited to a simulated fuel source (e.g., logs) and/or a grate.

A cover 94, optionally a translucent material, may extend between the top portion 87 and the bottom portion 88 of the housing 86. The cover 94 may be positioned behind the simulated ember bed 92. An array of LEDs 12 may be positioned behind the cover 94 and within the housing 86. The array of LEDs 12 may be configured to display dynamic lighting, including flickering, pulsing, and/or changing colors, to emulate a burning flame. The cover 94 may obscure and blur the light emitted by the array of LEDs 12 to emulate a wall of flames behind the simulated ember bed 92, and the emitted light may light portions of the room, such as a wall 13, the table 16, a floor, and/or a ceiling

In some examples, a reflective or semi-reflective back surface 96 of the housing 86 extends between the top portion 87 and bottom potion 88 of the housing 86. The back surface 96 may be positioned behind the cover 94. The housing 86 may support one or more fans (not shown) positioned behind the cover 94. The one or more fans are configured to blow air against the back surface 96 which creates an illusion of movement to emulate movement of burning flames in conjunction with, or alterative to, the dynamic lights of the array of LEDs 12. The cover 94 substantially prevents a user from viewing interior portions of the housing 86, including the fans, individual LEDs of the array of LEDs 12, and the back surface 96. In other examples, the back surface 96 may be a screen or LED panel displaying video or images 75 of burning flames.

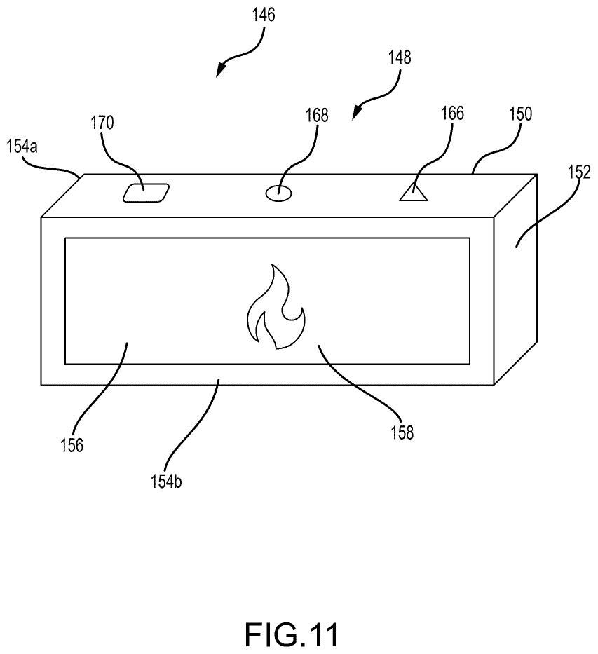

In some examples, the top portion 87 of the housing 86 supports one or more accessories 148 (FIG. 11-12), including a heating system 166. Further discussion on the one or more accessories 148 follows with respect to FIGS. 11-12.

FIG. 8 shows an electric light 98 in accordance with an embodiment. As shown, the electric light 98 includes a housing 100 with an embedded array of lights 102 that are arranged to spell a word 104. As shown, the array of lights 102 spells “LIGHTS”. In other examples, the array of lights 102 can display a family name (e.g., Smith) or values (e.g., peace, love, kindness), though any combination of words is contemplated. The array of lights 102 may include fiber optics, or LED lights. In some embodiments, the array of lights 102 are configured to flicker, pulse or change color to during operation. The array of lights 102 may be operatively coupled to a chaos circuit.

In other embodiments, the word(s) 104 may be stamped or cut out of the housing 100 (e.g., through-holes) and the array of lights 102 may be positioned within the housing 100 such that emitted light shines through the through-holes of the word 104. Similar to the other embodiments of the electric lights 10, 26, 34, 44, 60, 70, and 84 in FIGS. 1-7, the housing 100 may include a transparent cover 106 or film to blur the emitted light from the through-holes and create a flame effect behind the words 104.

The housing shown in FIG. 8 may be integrated with any of the previous embodiments such that any of the arrays of LEDs 12 may display a word 104.

FIGS. 9A-9C show an electric light 108 (FIGS. 9A), 110 (FIG. 9B), and 112 (FIG. 9C) in accordance with an embodiment. The electric lights 108, 110, 112 may include substantially similar elements as the electric lights 10, 26, 34, 44, 60, 70, 84, and 96 of FIGS. 1-8.

As shown in each of FIGS. 9A-9C, the electric lights 108, 110, 112 may be configured to mount onto a wall 13. The electric lights 108, 110, 112 may be configured to emulate an electric fireplace with simulated flames, or feature other visualizations with non-flame appearances. The electric lights 108, 110, 112 each include a housing 114 having a front face 116 and a rear face (not shown) opposite the front face 116 and facing the wall 13. The front face 116 may include a cover 118, optionally a transparent or semi-transparent cover, configured to display dynamic lighting provided by the array of LEDs 12 arranged in a planar display 120. The screen may extend substantially over a length of the housing 114, or may extend over only a portion of the length of the housing 114 such as three-quarters of the length of the housing 114, half of the length 122 of the housing 114, or less than half of the length of the housing 114.

The housing 114 includes a frame 124 defining a frame perimeter 126. The frame 124 surrounds a perimeter 119 of the cover 118. The frame perimeter 126 includes a top side 126a, a bottom side 126b opposite the top side 126a, a first side 126c, and a second side 126d opposite the first side 126c. A longitudinal axis is defined between the first and second sides 126c, 126d. The electric lights 108, 110, 112 may optionally include an enclosure on the rear facing side positioned against the wall 13 (not shown) to house electronic components, such as a power cord.

As shown, the housing 114 and the frame 124 may be generally rectangular, though other shapes such as squares are contemplated. In other embodiments, the frame 124 may include other unique or custom shapes including, but not limited to a U-shape or spiral shape. The array of LEDs 12 may be generally arranged to be coordinated to a shape of the frame 124 and/or the housing 114.

As shown in FIG. 9A, the dynamic lighting displayed by the array of LEDs 12 may be a visual representation of a fire including one or more flames 128. The dynamic lighting may include different colors, such as red, orange, yellow, or blue, to mimic natural flame lighting. The dynamic lighting may be controllable by a chaos circuit such that the LEDs of the array of LEDs 12 are configured to flicker, pulse, and/or change color to emulate a moving flame 128. In other embodiments, the plurality of LEDs 12 is a panel 102 (FIG. 20) and the panel 102 may be configured to show a video of the one or more flames 128.

As shown in FIG. 9B, the dynamic lighting includes shapes 130 other than flames, such as rectangular shapes. In some embodiments, the plurality of LEDs 12 may include multiple colors, which may optionally be arranged in a rainbow display (e.g., including one or more of red, orange, yellow, green, blue, purple, and/or pink) which may evoke other visual effects such as seasonal decorations or colors. Similar to the above embodiments, the dynamic lighting may be controllable by a chaos circuit such that the LEDs of the array of LEDs 12 may flicker, pulse, and/or change colors to emulate movement. In other embodiments, the plurality of LEDs 12 is a panel 102 (FIG. 20) and the panel 102 may be configured to show a video of the shapes 130.

As shown in FIG. 9C, the dynamic lighting may not define a particular shape, and instead may include an abstract light display 132, optionally including different colors. In some embodiments, the plurality of LEDs 12 may randomly display different colors which may continuously change over time. Similar to the above embodiments, the dynamic lighting may be controllable by a chaos circuit such that the LEDs of the array of LEDs 12 may flicker, pulse, and/or change colors to emulate movement. In other embodiments, the plurality of LEDs 12 is a panel 102 (FIG. 20) and the panel 102 may be configured to show a video of the abstract light display 132.

FIG. 10 shows an electric light system 134, including rear-facing lighting elements 136 in accordance with an embodiment. The electric light system 134 may include substantially similar elements as the electric lights 10, 26, 34, 44, 60, 70, 84, 96, 108, 110, and 112 of FIGS. 1-9C. FIG. 10 shows a digital display 138 with the one or more rear-facing lighting elements 136 positioned behind the digital display 138. The one or more rear-facing lighting elements 136 may include an electric light 140 having an array of LEDs 12, and the electric light 140 may include features of any of the embodiments described herein. In one embodiment, the one or more rear-facing lighting elements 136 are coupled to the digital display 138 at or near a rear face of the digital display 138 (e.g., facing a wall 13), opposite a screen of the digital display 138.

The one or more rear-facing lighting elements 136 may be configured to display a light 142 on portions of the wall 13 and/or the floor 15 behind the digital display 138 to enhance lighting in the environment surrounding the electric light system. In one example, the digital display 138 may display a visual representation of a flame 144, and the one or more rear-facing lighting elements 136 are configured to emulate lighting emitted from a burning flame. The one or more rear-facing lighting elements 136 may cast both light 142 and shadows onto the wall 13 and/or the floor 15 to extend and enhance the illusion of flames. In some embodiments, the one or more rear-facing lighting elements 136 display dynamic lighting configured to simulate a flame effect. In other embodiments, the digital display 138 may be a television coupled to a cable system, and the one or more rear-facing lighting elements 136 may provide lighting to the digital display 138, which is optionally a television. Although a television is shown, the one or more rear-facing lighting elements 136 may be used with other features in a home, or may be used independently thereof.

As described above with respect to FIGS. 1-9C, the one or more rear-facing lighting elements 136 may include a cover extending over at least a portion of the one or more rear-facing lighting elements 136, including over at least a portion of the plurality of the LEDs 12. The cover may comprise materials that are translucent, semi-translucent, semi-transparent, transparent, or semi-opaque to blur or otherwise semi-obstruct the individual lights of the array of LEDs 12 to further simulate a flame appearance.

FIG. 11 shows an embodiment of the electric light 146 with one or more accessories 148 operatively coupled to a housing 150. The electric light 146 may include features of any of the embodiments of FIGS. 1-9C, including the array of LEDs 12. The one or more accessories 148 may be positioned anywhere along a perimeter 152 of the housing 150, including along a side 154 of the housing 150, including along a top side 154a of the housing 150, or along a bottom side 154b of the housing 150. For illustration, the one or more accessories 148 are shown coupled on a top side 154a of the housing 150. The electric light 146 includes a cover 156 and the array of LEDs 12 to display a visual representation of a fire 158, including flames.

FIG. 12 shows a diagram of the one or more accessories 148 in communication with a controller 160. The controller 160 may be operatively coupled to a user device 162, including but not limited to, a remote control, a smart home system, or a personal electronic device such as a cell phone or laptop.

The controller 160 may be or include one or more processing units, such as a central processing unit (“CPU”), and one or more memory units that may be or include a non-transitory computer-readable medium that stores instructions which, when executed by the processing unit(s), causes the processing unit(s) to perform or run one or more processes, algorithms, or operations as stored in the medium. Examples of such memory units may include, but are not limited to, random access memories, read only memories, flash memories, disk drives, removable storages, and any other suitable types of storage as known in the art. The controller 160 is capable of receiving, analyzing, and transmitting electrical signals. The controller 160 is operatively coupled with at least a display and/or a heating system 166, and is capable of controlling, in response to a user input such as electrical signals transmitted from a user device 162, the operation of the display and the heater, as well as other accessories with which the controller 160 may be operatively coupled.

In some examples, user inputs may be provided remotely via one or more user devices 162 such as a smartphone or remote controller. User inputs may be wirelessly transmitted using a remote controller (e.g., wireless and/or wired control source), software application (“app”) on the user device, and/or other controller(s) as incorporated in the electric lights and/or the electric fireplaces.

The one or more accessories 148 can include a heating system 166 to optionally simulate heating of a burning fireplace. The heating system 166 may include one or more heaters positioned along the housing 150 (FIG. 11). The heaters can include, but are not limited to electric powered heaters or gas powered heaters. The one or more heaters may be operatively coupled to a fan and a vent of the heating system 166 to allow the heat to flow outwardly from the electric light 146 to provide heat to the environment (e.g., a room).

In some embodiments, the heating system 166 can be turned on and off using the controller 160. For example, the user can use the smart home system (e.g., as facilitated by an app) to turn the heating system 166 on and off. For example, the controller 160 can be used to selectively turn the heat up to increase the temperature of the room or selectively turn the heat down to decrease a temperature of the room. In other embodiments, the housing 150 may include a user input (e.g., a button, dial, or a switch) that allows the user to manually turn the heating system 166 on and off, or control an amount of heat.

In some embodiments, the heating system 166 may be operatively coupled to a driver of the array of LEDs 12. For example, the amount of heat provided to the environment may be generally represented by one or more parameters of the dynamic lighting, including but not limited to a size of the lighting, a frequency of the flicker or pulsing of the light, and/or a color of the light. For example, when the heat is turned up to increase the temperature of the room, the array of LEDs 12 can optionally increase a size of the emitted light to indicate a relatively hotter system, can optionally turn a warm color such as red, or can optionally increase in frequency of pulsing or flickering. When the heat is turned down to decrease the temperature of the room, the array of LEDs 12 can optionally decrease a size of the emitted light to indicate a cooler system, can optionally turn a cool color such as blue, or can optionally increase in frequency of pulsing or flickering.

The one or more accessories 148 may also include a speaker system 168 to provide audio optionally simulating a burning fireplace. In other embodiments, the speaker system 168 may be operable to play music or other sounds as controlled by a user. The speaker system 168 may include one or more speakers positioned along the perimeter 152 of the housing 150 (FIG. 11). In some embodiments, the speaker system 168 can be turned on and off using the controller 160. For example, the user can use the smart home system (e.g., as facilitated by an app) to turn the speaker system 168 on and off, or to adjust a volume of the speaker system 168. In other embodiments, the housing 150 may include a user input (e.g., a button, dial, or a switch) that can manually turn the speaker system 168 on and off and/or adjust a volume of the speaker system 168.

In some embodiments, the speaker system 168 may be operatively coupled to a diver of the array of LEDs 12. For example, the volume of sound provided to the environment may be generally represented by one or more parameters of the dynamic lighting, including but not limited to a size of the lighting, a frequency of the flicker or pulsing of the light, and/or a color of the light. In some embodiments, the amount of heat and the volume of sound provided to the environment are operatively coupled and rise and fall together. For example, when the heat is turned up, the volume of sound may increase, and the array of LEDs 12 may optionally increase a size of the emitted light, optionally pulse or flicker at an increased frequency, or optionally change to a warm color such as red. When the heat is turned down, the speaker volume may also decrease, and the array of LEDs 12 may optionally decrease a size of the emitted light, optionally pulse or flicker at a decreased frequency, or optionally change to a cool color such as blue. In other examples, one or more parameters of the array of LEDs 12 may be configured to change with music playing through the speakers. For example, the array of LEDs 12 may be configured to flicker or pulse at a frequency correlated to the beat of the music, or the light may change colors correlated to the beat of the music.

The one or more accessories 148 may also include a scent diffuser system 170 configured to provide a scent to the environment, which may simulate a burning candle. The scent diffuser system 170 may include one or more scent diffusers positioned along the perimeter 152 of the housing 150 (FIG. 11). In some embodiments, the scent diffuser system 170 can be turned on and off using the controller 160. For example, the user can use the smart home system (e.g., as facilitated by an app) to turn the scent diffuser system 170 on and off, or to adjust an amount of scent produced by the scent diffuser system 170. In other embodiments, the housing 150 may include a user input (e.g., a button, dial, or a switch) that can manually turn the scent diffuser system 170 on and off and/or adjust the scent output.

In some embodiments, the array of LEDs 12 may be operatively coupled to the controller 160. As such, a user may selectively turn on or off the lighting using the controller 160. In some embodiments, a driver of the array of LEDs 12 is operatively coupled to the controller 160 and may be controlled by the smart home system to change one or more elements of the lighting display.

The array of LEDs 12 may also be configured to respond to changes in the one or more accessories via the controller 160. For example, when the amount of heat of the heating system 166 is increased, the lighting may brighten and when the heat of the heating system 166 is decreased, the lighting may dim. Similarly, when the amount of sound of the speaker system 168 is increased, the lighting may brighten and when the sound of the speaker system 168 is decreased, the lighting may dim.

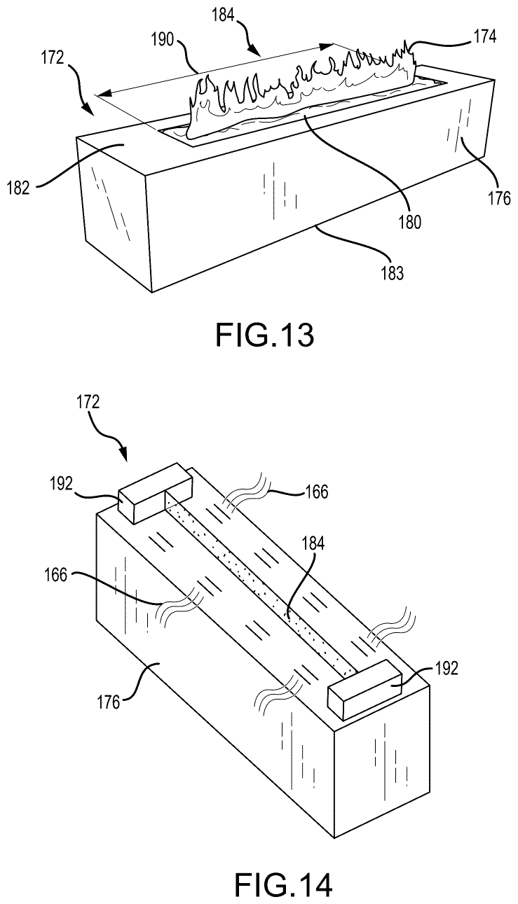

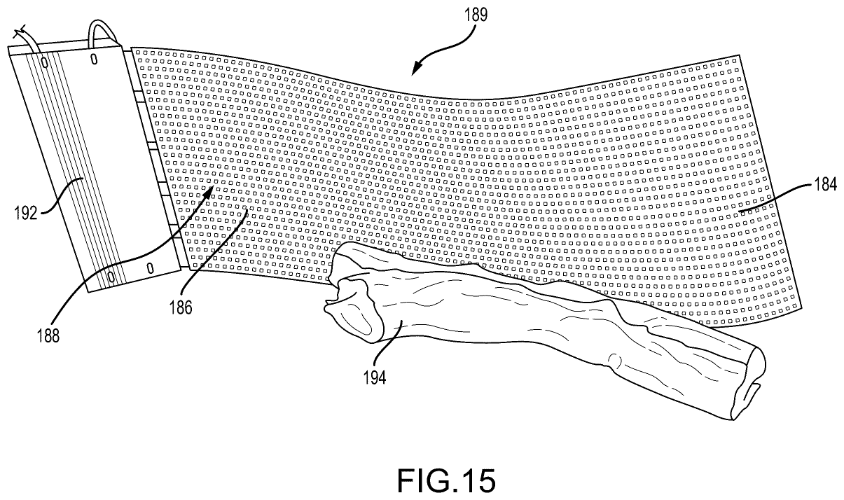

FIGS. 13-14 illustrate an embodiment of an electric fireplace 172 with a simulated flame 174, in accordance with an embodiment. The electric fireplace 172 includes a housing 176. The housing 176 is optionally constructed of an opaque material such as concrete, or is constructed of a transparent, semi-transparent, translucent, or a semi-translucent material such that light is at least partially transmitted through one or more surfaces of the housing 176. The electric fireplace 172 includes an ember bed 180 at a top surface 182 of the housing 176, which may include decorated logs, coal, or other decorative fuel sources. The electric fireplace 172 of FIGS. 13-14 does not require use of a gas line, a gas tank, or other fuel sources. Instead, a plurality of LED lights, arranged as an LED panel 184 (FIG. 15), may extend outwardly from the ember bed 180 to simulate the appearance of flames 174. The LED panel 184 may be operatively coupled to the controller 160, similar to the controller 160 shown and described with respect to FIG. 12. The LED panel 184 may also be coupled to the chaos circuit 164 that is configured to change the light emitted such that the light mimics movement of burning flames to enhance the realism of the simulated flames 174.

The LED panel 184 (FIG. 15) includes LED lights 186 on both a front face 188 and a rear face 189 of the LED panel 184 such that the LED panel 184 can provide lighting in at least two directions. This increases the viewing angles for the user. As such, the electric fireplace 172 can be positioned in a variety of manners including, but not limited to, being centered in a room, positioned between two viewing areas, or positionable in more than one configuration. The user has flexibility in positioning of the electric fireplace 172.

In prior art examples, simulated fireplaces can utilize mist to produce a flame simulation, but the mist is not compatible with outdoor environments. For example, the mist is not compatible with a windy or rainy environment and typically is unable to produce a flame simulation under such conditions. Additionally, mist does not provide lighting for the user. In contrast, the electric fireplace 172 of FIGS. 13-14 may be compatible with both indoor and outdoor environments. The LED panels 184 provide lighting to the users and the LED panels 184 may be water and/or weather resistant such that the LED panels 184 are resilient to withstand a variety of weather events. For example, the LED panel 184 is still operable in rainy or windy environments.

As shown in FIG. 13, in some embodiments, the LED panel 184 may include multiple, separated strips of the LED panels 184 that can mimic a line of simulated flames 174. The separated strips of the LED panels 184 may be coupled to the housing 176 and extend through the ember bed 180. As shown in FIG. 14, in other embodiments, the LED panel 184 may extend along a single strip across at least a portion of the length 190 of the ember bed 180. The single strip LED panel 184 may be coupled to the housing 176 via couplers 192 extending from the housing 176 and positioned at opposing ends of the single strip of LED panels 184. An example of the LED panel 184 is shown in FIG. 15, wherein the LED panel 184 extends from the ember bed 180, which optionally includes the decorative logs 194. The single strip LED panel 184 may include a plurality of LED lights 186, including but not limited to, micro-LED lights.

The LEDs 186 of the LED panels 184 can provide deeper contrasts (e.g., deeper blacks and/or more vibrant colors) and increased brightness/Nit valve (e.g., where Nit is defined as candela per meter squared (m2) measured at 1 meter from the light source) as compared to that of an LCD screen. As such, a viewing angle of the LEDs may be greater than that of the LCD screen due to the contrast and brightness. Additionally, the LED panel 184 may provide a longer lifespan as compared to an LCD screen. In some examples, a lifespan of the LED panel 184 may be on the order of about 100,000 hours and a lifespan of the LCD screen may be on the order of about 60,000 hours. The increase in lifespan can improve user experience by reducing the need to service and/or replace parts of the electric fireplace 172. Additionally, the LED panel 184 of the electric fireplace 172 may be repaired and/or replaced instead of requiring replacement of the entire screen or the entire electric fireplace.

The electric fireplaces of FIGS. 13-14 may include one or more heating systems 166 (FIG. 11) positioned at one or both of the top surface 182 of the housing 176 (e.g., near the ember bed 180) and/or at a bottom 183 of the housing 176. Having the heating system(s) 166 positioned at the bottom 183 of the housing 176 may provide heat toward the feet of one or more users, particularly in situations where users are sitting around the electric fireplace 172, such as in an outdoor setting to mimic a campfire. Similar to other embodiments discussed above, the electric fireplace 172 may also include other accessories 148 such as a speaker system 168 (FIG. 11) and/or a scent diffusing system 170 (FIG. 11). The accessories 148, including the heating system 166, the speaker system 168, and the scent diffusing system 170 may be operatively coupled to the controller 160 (FIG. 12), similar to the manner as shown and described with respect to FIG. 12.

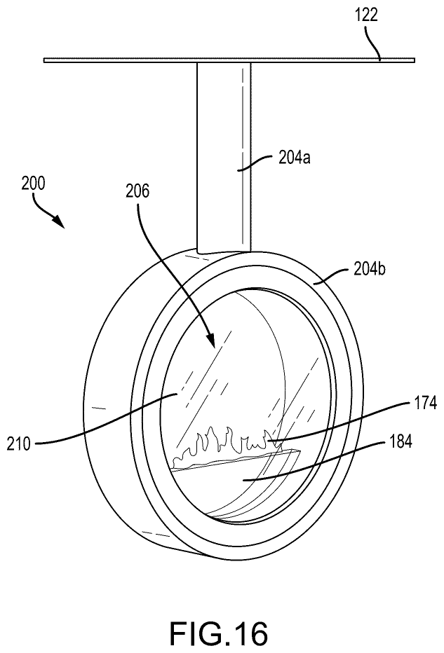

FIG. 16 illustrates another embodiment of an electric fireplace 200 configured to be suspended within a building, such as from a ceiling 122, in accordance with an embodiment. The electric fireplace 200 does not require the use of gas lines or other fuel sources. The electric fireplace 200 includes a housing 204 having a first portion 204a configured to be mounted onto a wall, such as the ceiling 122, and a second portion 204b defining a chamber 206 configured to display a visual representation of a fire 174. The chamber 206 may include a cover material 210. In some embodiments, the cover material 210 is one of a transparent, semi-transparent, translucent, or semi-translucent material such that light is able to project through the cover material 210. The second portion of the housing 204b may define a shape, including but not limited to a rounded or circular shape, though other shapes are contemplated such as rectangles, squares, trapezoids, triangles, and others. Within the chamber 206, an LED panel 184 extends along a length of the second portion 204b of the housing 204. The LED panel 184 may be secured within the cover material 210. The LED panel 184 is configured to display a simulated fire 174. In some embodiments, the LED panel 184 displays a video of burning flames. In other embodiments, the LED panel 184 may be operatively coupled to a chaos circuit 164 allowing lights to flicker or blink such that the simulated flames appear to move, simulating a real burning flame.

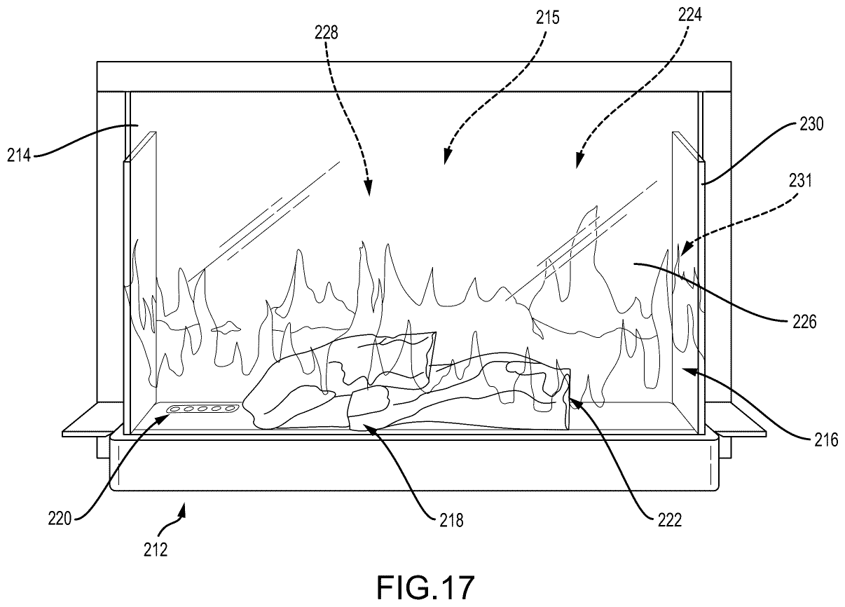

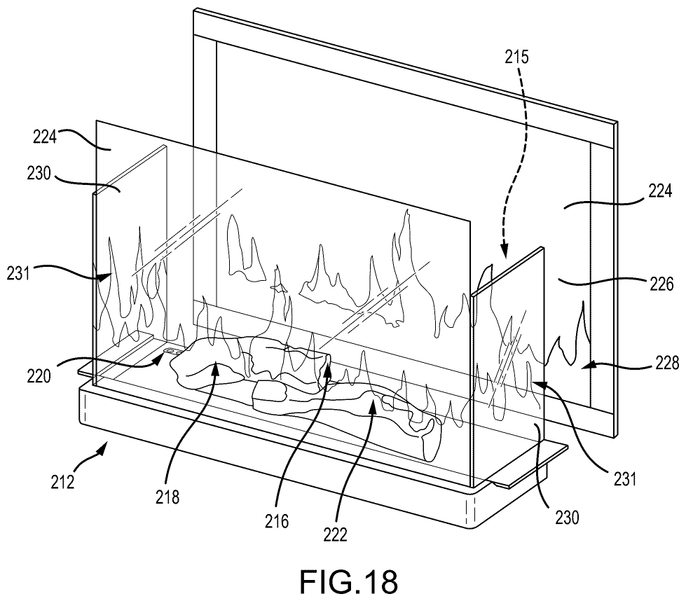

FIGS. 17-18 shows embodiments of a layered electric fireplace 212, which can simulate a fireplace depth and increase viewing angles for users. FIG. 17 is a layered electric fireplace 212 including a first display 214 at a front face 216 of the layered electric fireplace 212. The first display 214 includes a plurality of LED lights, arranged as the LED panel 184 (FIG. 20), and is configured to show a first image 218, such as flames, in a foreground of the layered electric fireplace 212. As discussed with respect to the foregoing examples, the LED panel 184 may be operatively coupled to a chaos circuit 164 to mimic movement of real flames. In other embodiments, the first display 214 is configured to play one or both of videos and images of a fire to simulate burning flames. The first display 214 may be transparent, semi-transparent, translucent, and semi-translucent. In embodiments, the user can see through at least a portion of the first display 214 and toward an interior 215 of the layered electric fireplace 212. Through the first display 214, the user may also view a second display 226 at a rear face of the layered fireplace 212, the side display(s) 230, and/or the bottom portion 220 of the layered electric fireplace 212. The interior 215 is defined as the space between each of the first display 214, the second display 226, the side display(s) 230, and the bottom portion 220.

The side display(s) 230 may be transparent, semi-transparent, translucent, and semi-translucent. In embodiments, the user can see through at least a portion of the side display(s) 230 and toward the interior 215 of the layered electric fireplace 212.

Optionally, a bottom portion 220 of the layered electric fireplace 212 includes a plurality of LED lights 186, which can simulate an ember bed. The plurality of LED lights 186 can twinkle or blink on and off to simulate a real ember bed of a fireplace. In other embodiments, the plurality of LED lights 186 of bottom portion 220 are configured to display video and/or images of a fire and/or the ember bed. The video and/or images may also include ember bed media, such as logs or coals. In some embodiments, the users can see movement of the light of the ember bed through the first display 214. In some embodiments, decorative fuel sources 222, such as decorative logs, coal, or other simulated fuel sources, can be placed on the bottom portion 220 of the layered fireplace 212 to enhance realism.

The layered electric fireplace 212 includes a rear face 224 opposite the front face 216. A second display 226 is positioned at the rear face 224, where the second display 226 can include a second LED panel 184 or a screen. The second display 226 may be configured to display a second image 228, which may be different from the first image 218, or the same as the first image 218. The second image 228 can include another representation of the fire (e.g., a second flame) and/or may include a background, such as a bricks, stone, or outdoor scenery.

In some embodiments, the first and the second displays 214, 226 are operatively coupled to the controller 160. A user may control, via the user device 162, one or more of a foreground image and/or a background image of the layered electric fireplace 212. In some examples, the first image 218 (e.g., the foreground image) is the visual representation of the fire. The first image 218 may be changed to include fire with various intensity (e.g., small, medium, or large) and fireplace types (e.g., driftwood, firepit, or gas flame). The second image 228 (e.g., a background image) may include various textures or sceneries (e.g., bricks, stones, or outdoor sceneries). In some examples, the first and second images 218, 228 may be preconfigured such that the user may select one or more of the preconfigured foreground and/or background elements separately or together as a set. When selected as a set, the combination of the preconfigured first and second images 218, 228 may be displayed, replacing the current image or video that is displayed on one or both of the displays 214, 226. When one of the first and second images 218, 228 is selected, the selected foreground or background element may replace the corresponding foreground or background element of the current image or video that is displayed on the display 214, 226. As such, the first and second displays 214, 226 of the layered electric fireplace 212 may be fully customizable by the user. In some examples, videos may be displays instead of, or in addition to, the images.

FIG. 18 illustrates an embodiment in which the layered electric fireplace 212 includes a side display(s) 230 on one or both side portions on the layered electric fireplace 212. The side display(s) 230 can be positioned between the first and second displays 214, 226 and can display a third image 231. The first display 214, the second display 226, and the side display(s) 230 define an outer perimeter of the layered electric fireplace 212. In some examples, the visual representation of the fire in the first image 218 and the third image 231 can wrap around the outer perimeter of the layered electric fireplace 212 such that the users can see the visual representation of the fire from multiple viewing angles. As shown, the visual representation of the fire in the first image 218 and the third image 231 may extend up to, and around, edges between the first display 214 and the side display(s) 230. A visual representation of the fire may extend substantially continuously and un-interrupted along the first display 214 and the side display(s) 230. The visual representation of the fire may be a video instead of, or in addition to, the images. The third image 231 on the side display(s) 230 may face outwardly from the layered fireplace 212, such as toward an exterior, surrounding environment. In other embodiments, the visual representation of the fire on the side display(s) 230 faces toward the interior 215 of the layered fireplace 212, such as toward a center of the layered fireplace 212. In other embodiments, one of the side display(s) 230 may face outwardly from the layered fireplace 212 and another of the side display(s) 230 may face toward the interior 215 of the layered fireplace 212.

The layered electric fireplaces 212 of both FIGS. 17-18 are configured to enhance a user's viewing experience by simulating depth of the simulated flames. For example, the visual representation of the fire is presented in each of the foreground, bottom, background, and optionally the sides of the layered electric fireplaces, and as such, even though the visual representation of the fire is being displayed on a two-dimensional LED panel 184, the user experiences a three-dimensional visual. This enhances the realism of the layered electric fireplace 212 and simulates features of a real burning flame.

FIG. 20 shows an example of the LED panel 184 comprised of a plurality of LEDs 186, and optionally a cover 248. The LED panel 184 may be used in any of the embodiments in FIGS. 1-19. In some embodiments, the cover 248 is one of a transparent, semi-transparent, translucent, or semi-translucent material. In other embodiments, the LED panel 184 does not include the cover 248, and instead, the LED panel 184 itself includes a transparent, semi-transparent, translucent, or semi-translucent material. The LED panel 184 may be made of a flexible material. In some embodiments, the LED panel 184 displays images and/or video of burning flames. In other embodiments, the LED panel 184 may be operatively coupled to a chaos circuit 164 allowing lights to flicker or blink such that the simulated flames appear to move, simulating a real burning flame.

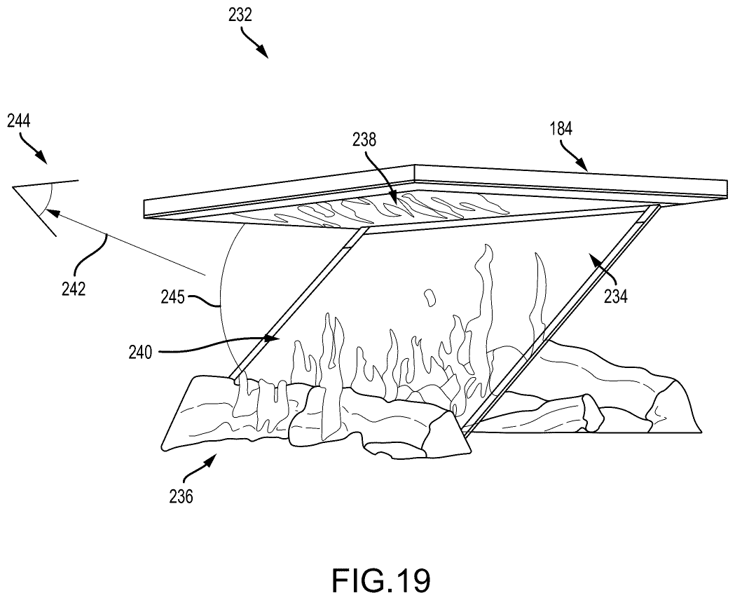

Turning to FIG. 19, in some embodiments, an electric fireplace 232 can include at least one LED panel 184, a cover material 234, and optionally, physical media 236 As shown, the at least one LED panel 184 may be mounted or otherwise suspended above the cover material 234. The cover material 234 is positioned below the at least one LED panel 184 and is positioned at an angle relative to the at least one LED panel 184. The at least one LED panel 184 may display a visual representation of the fire 238 and reflect the physical representation of the fire 238 onto the cover material 234. The cover material 234 may then display a reflected representation of the fire 240 outwardly to the user, as shown by the arrow 242. The angle of the cover material 234 may be such that the reflected visual representation of the fire 240 is directed outwardly, toward the user 244 and toward the surrounding environment. Optionally, the reflected visual representation of the fire 240 is reflected upwards toward the user 244 and toward the surrounding environment. The LED panel 184 may display a realistic image of fire, and the reflected representation of the fire 240 may soften the image for the user, to simulate a live fire. The cover material 234 may also obscure the individual LED lights 186 of the LED panel 184 such that they are hidden from view. A viewing angle 246 of the electric fireplace 232 may be such that the LED panel 184 is hidden from view and the user sees just the reflected representation of the fire 240 and optionally the physical media 236. The cover 248 may also cover or obscure the LEDs 186 from view (FIG. 20). For example, by obscuring and/or hiding the features of the LED lights 186, the user is able to view the reflected visual representation of the fire 240 without obstruction.

The electric fireplace 232 of FIG. 19 may include the accessories as described with respect to FIGS. 6-7. The physical media 236 includes, but is not limited to, decorative logs or coal. The physical media 236 may be positioned in front of the cover material 234, may surround a side of the cover material 234, may be positioned behind the cover material 234, or a combination thereof.

The cover material 234 can include, but is not limited to, a glass, a frosted glass, acrylic, frosted or patterned acrylic, or another light diffusing material. In some embodiments, where the cover material 234 is at least semi-transparent, the physical media 236 may be positioned both front of and behind the cover material 234. The cover material 234 is reflective or semi-reflective to produce the reflected visual representation of the fire 240 for the user 244. The cover material 234 may also include polarizing coating to prevent or reduce glare from other lighting in the environment such that the reflected visual representation of the fire 240 is substantially uninterrupted.

The electric lights and electric fireplaces of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

Various modifications and additions can be made to the exemplary embodiments discussed without departing from the scope of the present invention. For example, while the embodiments described above refer to particular features, the scope of the invention also includes embodiments having different combinations of features and embodiments that do not include all of the above-described features.

1. An electric light system, the electric light system comprising:
a housing;
an array of light elements arranged in a planar display coupled to the housing, the array of light elements configured to display dynamic lighting;
a cover extending over at least a portion of the array of light elements;
a controller operatively coupled to the array of light elements; and
a heating system including at least one heater associated with the housing.

2. The electric light system of claim 1, wherein the controller is configured to be operatively coupled to a smart home system.

3. The electric light system of claim 2, wherein the heating system is configured to be operatively coupled to the smart home system, and optionally wherein the heating system is configurated to be operatively coupled to the smart home system via the controller.

4. The electric light system of claim 1, further including a speaker system including at least one speaker associated with the housing, wherein the speaker system is configured to be operatively coupled to a smart home system.

5. The electric light system of claim 1, further including a scent diffusion system including at least one scent diffuser coupled to the housing, wherein the scent diffusion system is configured to be operatively coupled to a smart home system.

6. The electric light system of claim 1, wherein the array of light elements includes a plurality of LEDs.

7. The electric light system of claim 6, wherein the plurality of LEDs are arranged in a matrix, and optionally wherein the matrix is one of a transparent, semi-transparent, translucent, or semi-translucent material.

8. The electric light system of claim 1, wherein the cover includes at least one of a transparent, semi-transparent, translucent, semi-translucent, opaque, or semi-opaque material.

9. The electric light system of claim 1, wherein the electric light system includes a light extender configured to extend the lighting outwardly from the housing, the light extender including at least one of goboes, LEDs, and a projector.

10. The electric light system of claim 1, wherein the housing includes one or more embedded lights configured to display a word.

11. The electric light system of claim 1, wherein the housing includes one or more through-holes defining a shape.

12. The electric light system of claim 10, wherein the shape is a flame.

13. The electric light system of claim 1, wherein the housing is a table.

14. The electric light system of claim 1, wherein the dynamic lighting simulates one of a flame, a shape, or abstract lighting.

15. An electric fireplace comprising:
a housing;
a first display positioned at a front of the housing, the first display producing a first visual representation of a fire;
a second display positioned at a rear of the housing opposite to the front of the housing, the second display producing a second visual representation of a fireplace, wherein the first and second display together provide a perceived depth to the electric fireplace; and
a controller operatively coupled to the first and second displays, the controller operable to change one or more properties of the first and second displays in response to a user-input.

16. The electric fireplace of claim 15, further including a third display positioned along a side of the housing and extending between the first and second displays, the third display producing a third visual representation of a fireplace.

17. The electric fireplace of claim 16, wherein the first, second, and third display include LED panels, wherein at least one of the LED panels includes a transparent, semi-transparent, translucent, or semi-translucent material.

18. The electric fireplace of claim 16, wherein the first, second, and third displays define an outer perimeter of the housing, wherein the first and third visual representations of the fireplace are substantially continuous.

19. The electric fireplace of claim 15, further including a simulated ember bed at a bottom of the housing, the simulated ember bed including a plurality LED lights configured to blink on and off.

20. The electric fireplace of claim 19, wherein the simulated ember bed is operably coupled to a chaos circuit.

21. The electric fireplace of claim 15, further including a simulated ember bed at a bottom of the housing, the simulated ember bed including an LED panel configured to display at least one of an image or a video of an ember bed.

22. The electric fireplace of claim 15, wherein the first display is at least partially transparent and optionally wherein the second display is at least partially transparent.

23. An electric fireplace comprising:
a housing;
an LED panel coupled to a top portion of the housing, the LED panel displaying a visual representation of a fire;
a cover material coupled to a bottom of the housing and positioned at an angle relative to the bottom of the housing, the cover material having one of a reflective or semi-reflective property, the cover material positioned such that the visual representation of the fire from the LED panel is reflected onto the cover material to produce a reflected visual representation of a fire, and wherein the reflected visual representation of the fire is directed outwardly toward a user.

24. The electric fireplace of claim 23, further including a simulated ember bed positioned at the bottom portion of the housing.

25. The electric fireplace of claim 23, wherein the cover material obscures features of the LED panel such that the reflected visual representation of a fire simulates a real fire.

26. An electric light system for use with a smart home system, the electric light system comprising:
a housing having a front facing side and a rear facing side opposite the front-facing side, the front facing side including a translucent screen;
an array of one or more light elements supported by the housing, the array of one or more light elements configured to display dynamic lighting including one of flickering, pulsing, or changing colors;
a speaker assembly coupled to the housing;
a heating assembly coupled to the housing; and
a controller operatively coupled to the array of one or more light elements, the speaker assembly, and the heating assembly, the controller configured to form part of a smart home system,
wherein the electric light system is configured to change a feature of the array of the one or more light elements according to at least one of an input signal to and an output signal from at least one of the speaker assembly and the heating assembly.

27. The electric light system of claim 26, wherein when the electric light system is configured to operate such that an increase in heat production of the heat assembly is coordinated to an increase in a frequency of one of the flickering, pulsing, and changing color of the one or more light elements.

28. The electric light system of claim 26, wherein the electric light system is configured to operate such that a decrease in heat production of the heat assembly is coordinated to a decrease in a frequency of one of the flickering, pulsing, and changing color of the one or more light elements.

29. The electric light system of claim 26, wherein the electric light system is configured to operate such that an increase in volume of the speaker assembly is coordinated to an increase in a frequency of one of the flickering, pulsing, and changing color of the one or more light elements.

30. The electric light system of claim 26, wherein the electric light system is configured to operate such that a decrease in volume of the speaker assembly is coordinated to a decrease in a frequency of one of the flickering, pulsing, and changing color of the one or more light elements.

31. The electric light system of claim 26, wherein the electric light system is configured to operate such that an increase in brightness of the array of light elements is coordinated to an increase in a frequency of one of the flickering, pulsing, and changing color of the one or more light elements.

32. The electric light system of claim 26, wherein the electric light system is configured to operate such that a decrease in brightness of the array of light elements is coordinated to a decrease in a frequency of one of the flickering, pulsing, and changing color of the one or more light elements.
